(19) United States
(12) Patent Application Publication
(10) Pub. No.: US 2020/0287284 A1
(43) Pub. Date: Sep. 10, 2020

(54) ANTENNA HAVING PROTRUSIONS WITH STEPPED WIDTHS

(71) Applicant: WILSON ELECTRONICS, LLC, St. George, UT (US)

(72) Inventors: Taehee Jang, Allen, TX (US); Christopher Ken Ashworth, Toquerville, UT (US); Brooks Stephen Ruhman, Dallas, TX (US)

(21) Appl. No.: 16/804,316

(22) Filed: Feb. 28, 2020

Related U.S. Application Data
(60) Provisional application No. 62/814,786, filed on Mar. 6, 2019.

(51) Int. Cl. H01Q 5/371; H01Q 9/18

(52) U.S. Cl. CPC H01Q 5/371; H01Q 9/18

(57) ABSTRACT

Technology for an antenna is disclosed. The antenna can include a center feed line and a plurality of antenna elements carried by the center feed line. An antenna element in the plurality of antenna elements can have a selected length and a selected width with a first end of the antenna element carried by the center feed line and a second end of the antenna element can be disposed distally from the center feed line. Two or more antenna elements of the plurality of antenna elements can each include a protrusion with a stepped width over a selected length. The protrusion can be located proximate to the second end of the antenna element, and the protrusion can have a width that is greater than the selected width of the antenna element.

### RELATED APPLICATIONS

The present application claims the benefit of U.S. Provisional Patent Application No. 62/814,786, filed Mar. 6, 2019 with a docket number of 3969-174.PROV, the entire specification of which is hereby incorporated by reference in its entirety for all purposes.

### BACKGROUND

Signal boosters and repeaters can be used to increase the quality of wireless communication between a wireless device and a wireless communication access point, such as a cell tower. Signal boosters can improve the quality of the wireless communication by amplifying, filtering, and/or applying other processing techniques to uplink and downlink signals communicated between the wireless device and the wireless communication access point.

As an example, the signal booster can receive, via an antenna, downlink signals from the wireless communication access point. The signal booster can amplify the downlink signal and then provide an amplified downlink signal to the wireless device. In other words, the signal booster can act as a relay between the wireless device and the wireless communication access point. As a result, the wireless device can receive a stronger signal from the wireless communication access point. Similarly, uplink signals from the wireless device (e.g., telephone calls and other data) can be directed to the signal booster. The signal booster can amplify the uplink signals before communicating, via an antenna, the uplink signals to the wireless communication access point.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a signal booster in communication with a wireless device and a base station in accordance with an example;

FIG. 2 illustrates a traditional wire antenna with antenna elements in accordance with an example;

FIG. 3 illustrates a wire antenna with L-shaped antenna elements in accordance with an example;

FIG. 4 illustrates a wire antenna that includes a plurality of antenna elements in accordance with an example;

FIG. 5 illustrates a repeater system that includes a dipole antenna communicatively coupled to a signal repeater in accordance with an example;

FIG. 6 illustrates an antenna element with a protrusion in accordance with an example;

FIG. 7 illustrates an antenna element with a protrusion in accordance with an example;

FIG. 8 illustrates an antenna element with a protrusion in accordance with an example;

FIG. 9 illustrates an antenna element with a protrusion and a selected angle in accordance with an example;

FIG. 10 illustrates a first antenna element carried by a top center feed line and a second antenna element carried by a bottom center feed line in accordance with an example;

FIG. 11 illustrates a first antenna element and a second antenna element carried by two center feed lines with an alternating phase at an offset in accordance with an example;

FIG. 12 illustrates a reflector for a wire antenna in accordance with an example;

FIG. 13 illustrates a return loss of a wire antenna with antenna elements having protrusions in accordance with an example;

FIG. 14 illustrates a return loss comparison between a wire antenna with antenna elements having protrusions and a dipole antenna with antenna elements not having protrusions in accordance with an example;

FIG. 15 illustrates an electric field distribution for a wire antenna having a plurality of antenna elements in accordance with an example; and

FIG. 16 illustrates a wireless device in accordance with an example.

Reference will now be made to the exemplary embodiments illustrated, and specific language will be used herein to describe the same. It will nevertheless be understood that no limitation of the scope of the invention is thereby intended.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

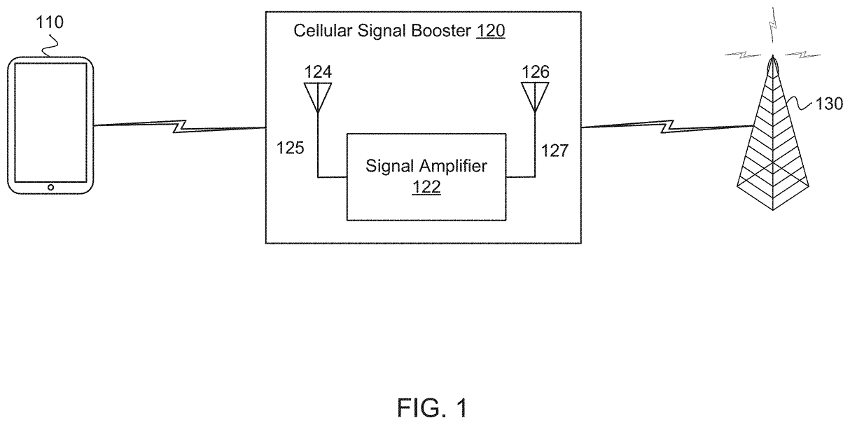

FIG. 1 illustrates an exemplary signal booster 120 in communication with a wireless device 110 and a base station 130. The signal booster 120 can be referred to as a repeater. A repeater can be an electronic device used to amplify (or boost) signals. The signal booster 120 (also referred to as a cellular signal amplifier) can improve the quality of wireless communication by amplifying, filtering, and/or applying other processing techniques via a signal amplifier 122 to uplink signals communicated from the wireless device 110 to the base station 130 and/or downlink signals communicated from the base station 130 to the wireless device 110. In other words, the signal booster 120 can amplify or boost uplink signals and/or downlink signals bi-directionally. In one example, the signal booster 120 can be at a fixed location, such as in a home or office. Alternatively, the signal booster 120 can be attached to a mobile object, such as a vehicle or a wireless device 110.

In one configuration, the signal booster 120 can include an integrated device antenna 124 (e.g., an inside antenna or a coupling antenna) and an integrated node antenna 126 (e.g., an outside antenna). The integrated node antenna 126 can receive the downlink signal from the base station 130. The downlink signal can be provided to the signal amplifier 122 via a second coaxial cable 127 or other type of radio frequency connection operable to communicate radio frequency signals. The signal amplifier 122 can include one or more cellular signal amplifiers for amplification and filtering. The downlink signal that has been amplified and filtered can be provided to the integrated device antenna 124 via a first coaxial cable 125 or other type of radio frequency connection operable to communicate radio frequency signals. The integrated device antenna 124 can wirelessly communicate the downlink signal that has been amplified and filtered to the wireless device 110.

Similarly, the integrated device antenna 124 can receive an uplink signal from the wireless device 110. The uplink signal can be provided to the signal amplifier 122 via the first coaxial cable 125 or other type of radio frequency connection operable to communicate radio frequency signals. The signal amplifier 122 can include one or more cellular signal amplifiers for amplification and filtering. The uplink signal that has been amplified and filtered can be provided to the integrated node antenna 126 via the second coaxial cable 127 or other type of radio frequency connection operable to communicate radio frequency signals. The integrated device antenna 126 can communicate the uplink signal that has been amplified and filtered to the base station 130.

In one example, the signal booster 120 can filter the uplink and downlink signals using any suitable analog or digital filtering technology including, but not limited to, surface acoustic wave (SAW) filters, bulk acoustic wave (BAW) filters, film bulk acoustic resonator (FBAR) filters, ceramic filters, waveguide filters or low-temperature co-fired ceramic (LTCC) filters.

In one example, the signal booster 120 can send uplink signals to a node and/or receive downlink signals from the node. The node can comprise a wireless wide area network (WWAN) access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or another type of WWAN access point.

In one configuration, the signal booster 120 used to amplify the uplink and/or a downlink signal is a handheld booster. The handheld booster can be implemented in a sleeve of the wireless device 110. The wireless device sleeve can be attached to the wireless device 110, but can be removed as needed. In this configuration, the signal booster 120 can automatically power down or cease amplification when the wireless device 110 approaches a particular base station. In other words, the signal booster 120 can determine to stop performing signal amplification when the quality of uplink and/or downlink signals is above a defined threshold based on a location of the wireless device 110 in relation to the base station 130.

In one example, the signal booster 120 can include a battery to provide power to various components, such as the signal amplifier 122, the integrated device antenna 124 and the integrated node antenna 126. The battery can also power the wireless device 110 (e.g., phone or tablet). Alternatively, the signal booster 120 can receive power from the wireless device 110.

In one configuration, the signal booster 120 can be a Federal Communications Commission (FCC)-compatible consumer signal booster. As a non-limiting example, the signal booster 120 can be compatible with FCC Part 20 or 47 Code of Federal Regulations (C. F. R.) Part 20.21 (Mar. 21, 2013). In addition, the signal booster 120 can operate on the frequencies used for the provision of subscriber-based services under parts 22 (Cellular), 24 (Broadband PCS), 27 (AWS-1, 700 MHz Lower A-E Blocks, and 700 MHz Upper C Block), and 90 (Specialized Mobile Radio) of 47 C.F.R. The signal booster 120 can be configured to automatically self-monitor its operation to ensure compliance with applicable noise and gain limits. The signal booster 120 can either self-correct or shut down automatically if the signal booster's operations violate the regulations defined in FCC Part 20.21.

In one configuration, the signal booster 120 can enhance the wireless connection between the wireless device 110 and the base station 130 (e.g., cell tower) or another type of wireless wide area network (WWAN) access point (AP). The signal booster 120 can boost signals for cellular standards, such as the Third Generation Partnership Project (3GPP) Long Term Evolution (LTE) Release 8, 9, 10, 11, 12, 13, 14, 15 or 16, 3GPP 5G Release 15 or 16, or Institute of Electronics and Electrical Engineers (IEEE) 802.16. In one configuration, the signal booster 120 can boost signals for 3GPP LTE Release 16.0.0 (January 2019) or other desired releases. The signal booster 120 can boost signals from the 3GPP Technical Specification (TS) 36.101 (Release 16 Jul. 2019) bands or LTE frequency bands. For example, the signal booster 120 can boost signals from the LTE frequency bands: 2, 4, 5, 12, 13, 17, 25, and 26. In addition, the signal booster 120 can boost selected frequency bands based on the country or region in which the signal booster is used, including any of bands 1-85 or other bands, as disclosed in 3GPP TS 36.104 V16.0.0 (January 2019), and depicted in Table 1:

TABLE 1

| LTE | Uplink (UL) operating band | Downlink (DL) operating band | |
|---|---|---|---|
| Operating | BS receive UE transmit | BS transmit UE receive | Duplex |
| Band | F_{UL}_{_{—}}_{low}-F_{UL}_{_{—}}_{high} | F_{DL}_{_{—}}_{low}-F_{DL}_{_{—}}_{high} | Mode |
| 1 | 1920 MHz-1980 MHz | 2110 MHz-2170 MHz | FDD |
| 2 | 1850 MHz-1910 MHz | 1930 MHz-1990 MHz | FDD |
| 3 | 1710 MHz-1785 MHz | 1805 MHz-1880 MHz | FDD |
| 4 | 1710 MHz-1755 MHz | 2110 MHz-2155 MHz | FDD |
| 5 | 824 MHz-849 MHz | 869 MHz-894 MHz | FDD |
| 6 | 830 MHz-840 MHz | 875 MHz-885 MHz | FDD |
| (NOTE 1) | | | |
| 7 | 2500 MHz-2570 MHz | 2620 MHz-2690 MHz | FDD |
| 8 | 880 MHz-915 MHz | 925 MHz-960 MHz | FDD |
| 9 | 1749.9 MHz-1784.9 MHz | 1844.9 MHz-1879.9 MHz | FDD |
| 10 | 1710 MHz-1770 MHz | 2110 MHz-2170 MHz | FDD |
| 11 | 1427.9 MHz-1447.9 MHz | 1475.9 MHz-1495.9 MHz | FDD |
| 12 | 699 MHz-716 MHz | 729 MHz-746 MHz | FDD |
| 13 | 777 MHz-787 MHz | 746 MHz-756 MHz | FDD |
| 14 | 788 MHz-798 MHz | 758 MHz-768 MHz | FDD |
| 15 | Reserved | Reserved | FDD |
| 16 | Reserved | Reserved | FDD |
| 17 | 704 MHz-716 MHz | 734 MHz-746 MHz | FDD |
| 18 | 815 MHz-830 MHz | 860 MHz-875 MHz | FDD |
| 19 | 830 MHz-845 MHz | 875 MHz-890 MHz | FDD |
| 20 | 832 MHz-862 MHz | 791 MHz-821 MHz | FDD |
| 21 | 1447.9 MHz-1462.9 MHz | 1495.9 MHz-1510.9 MHz | FDD |
| 22 | 3410 MHz-3490 MHz | 3510 MHz-3590 MHz | FDD |
| 23¹ | 2000 MHz-2020 MHz | 2180 MHz-2200 MHz | FDD |
| 24 | 1626.5 MHz-1660.5 MHz | 1525 MHz-1559 MHz | FDD |
| 25 | 1850 MHz-1915 MHz | 1930 MHz-1995 MHz | FDD |
| 26 | 814 MHz-849 MHz | 859 MHz-894 MHz | FDD |
| 27 | 807 MHz-824 MHz | 852 MHz-869 MHz | FDD |
| 28 | 703 MHz-748 MHz | 758 MHz-803 MHz | FDD |
| 29 | N/A | 717 MHz-728 MHz | FDD |
| | | | (NOTE 2) |
| 30 | 2305 MHz-2315 MHz | 2350 MHz-2360 MHz | FDD |
| 31 | 452.5 MHz-457.5 MHz | 462.5 MHz-467.5 MHz | FDD |
| 32 | N/A | 1452 MHz-1496 MHz | FDD |
| | | | (NOTE 2) |
| 33 | 1900 MHz-1920 MHz | 1900 MHz-1920 MHz | TDD |
| 34 | 2010 MHz-2025 MHz | 2010 MHz-2025 MHz | TDD |
| 35 | 1850 MHz-1910 MHz | 1850 MHz-1910 MHz | TDD |
| 36 | 1930 MHz-1990 MHz | 1930 MHz-1990 MHz | TDD |
| 37 | 1910 MHz-1930 MHz | 1910 MHz-1930 MHz | TDD |
| 38 | 2570 MHz-2620 MHz | 2570 MHz-2620 MHz | TDD |
| 39 | 1880 MHz-1920 MHz | 1880 MHz-1920 MHz | TDD |
| 40 | 2300 MHz-2400 MHz | 2300 MHz-2400 MHz | TDD |
| 41 | 2496 MHz-2690 MHz | 2496 MHz-2690 MHz | TDD |
| 42 | 3400 MHz-3600 MHz | 3400 MHz-3600 MHz | TDD |
| 43 | 3600 MHz-3800 MHz | 3600 MHz-3800 MHz | TDD |
| 44 | 703 MHz-803 MHz | 703 MHz-803 MHz | TDD |
| 45 | 1447 MHz-1467 MHz | 1447 MHz-1467 MHz | TDD |
| 46 | 5150 MHz-5925 MHz | 5150 MHz-5925 MHz | TDD |
| | | | (NOTE 3, |
| | | | NOTE 4) |
| 47 | 5855 MHz-5925 MHz | 5855 MHz-5925 MHz | TDD |
| 48 | 3550 MHz-3700 MHz | 3550 MHz-3700 MHz | TDD |
| 49 | 3550 MHz-3700 MHz | 3550 MHz-3700 MHz | TDD |
| | | | (NOTE 8) |
| 50 | 1432 MHz-1517 MHz | 1432 MHz-1517 MHz | TDD |
| 51 | 1427 MHz-1432 MHz | 1427 MHz-1432 MHz | TDD |
| 52 | 3300 MHz-3400 MHz | 3300 MHz-3400 MHz | TDD |
| 53 | 2483.5 MHz-2495 MHz | 2483.5 MHz-2495 MHz | TDD |
| 65 | 1920 MHz-2010 MHz | 2110 MHz-2200 MHz | FDD |
| 66 | 1710 MHz-1780 MHz | 2110 MHz-2200 MHz | FDD |
| | | | (NOTE 5) |
| 67 | N/A | 738 MHz-758 MHz | FDD |
| | | | (NOTE 2) |
| 68 | 698 MHz-728 MHz | 753 MHz-783 MHz | FDD |
| 69 | N/A | 2570 MHz-2620 MHz | FDD |
| | | | (NOTE 2) |
| 70 | 1695 MHz-1710 MHz | 1995 MHz-2020 MHz | FDD⁶ |
| 71 | 663 MHz-698 MHz | 617 MHz-652 MHz | FDD |
| 72 | 451 MHz-456 MHz | 461 MHz-466 MHz | FDD |
| 73 | 450 MHz-455 MHz | 460 MHz-465 MHz | FDD |
| 74 | 1427 MHz-1470 MHz | 1475 MHz-1518 MHz | FDD |
| 75 | N/A | 1432 MHz-1517 MHz | FDD |
| | | | (NOTE 2) |
| 76 | N/A | 1427 MHz-1432 MHz | FDD |
| | | | (NOTE 2) |
| 85 | 698 MHz-716 MHz | 728 MHz-746 MHz | FDD |
| 87 | 410 MHz-415 MHz | 420 MHz-425 MHz | FDD |
| 88 | 412 MHz-417 MHz | 422 MHz-427 MHz | FDD |

NOTE 1:
Band 6, 23 are not applicable.
NOTE 2:
Restricted to E-UTRA operation when carrier aggregation is configured. The downlink operating band is paired with the uplink operating band (external) of the carrier aggregation configuration that is supporting the configured Pcell.
NOTE 3:
This band is an unlicensed band restricted to licensed-assisted operation using Frame Structure Type 3.
NOTE 4:
Band 46 is divided into four sub-bands as in Table 5.5-1A.
NOTE 5:
The range 2180-2200 MHz of the DL operating band is restricted to E-UTRA operation when carrier aggregation is configured.
NOTE 6:
The range 2010-2020 MHz of the DL operating band is restricted to E-UTRA operation when carrier aggregation is configured and TX-RX separation is 300 MHz. The range 2005-2020 MHz of the DL operating band is restricted to E-UTRA operation when carrier aggregation is configured and TX-RX separation is 295 MHz.
NOTE 7:
Void
NOTE 8:
This band is restricted to licensed-assisted operation using Frame Structure Type 3.

In another configuration, the signal booster 120 can boost signals from the 3GPP Technical Specification (TS) 38.104 (Release 16 Jul. 2019) bands or 5G frequency bands. In addition, the signal booster 120 can boost selected frequency bands based on the country or region in which the repeater is used, including any of bands n1-n86 in frequency range 1 (FR1), n257-n261 in frequency range 2 (FR2), or other bands, as disclosed in 3GPP TS 38.104 V16.0.0 (July 2019), and depicted in Table 2 and Table 3:

TABLE 2

| NR | Uplink (UL) operating band | Downlink (DL) operating band | |
|---|---|---|---|
| operating | BS receive/UE transmit | BS transmit/UE receive | Duplex |
| band | F_{UL, low}-F_{UL, high} | F_{DL, low}-F_{DL, high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n12 | 699 MHz-716 MHz | 729 MHz-746 MHz | FDD |
| n14 | 788 MHz-798 MHz | 758 MHz-768 MHz | FDD |
| n18 | 815 MHz-830 MHz | 860 MHz-875 MHz | FDD |
| n20 | 832 MHz-862 MHz | 791 MHz-821 MHz | FDD |
| n25 | 1850 MHz-1915 MHz | 1930 MHz-1995 MHz | FDD |
| n28 | 703 MHz-748 MHz | 758 MHz-803 MHz | FDD |
| n30 | 2305 MHz-2315 MHz | 2350 MHz-2360 MHz | FDD |
| n34 | 2010 MHz-2025 MHz | 2010 MHz-2025 MHz | TDD |
| n38 | 2570 MHz-2620 MHz | 2570 MHz-2620 MHz | TDD |
| n39 | 1880 MHz-1920 MHz | 1880 MHz-1920 MHz | TDD |
| n40 | 2300 MHz-2400 MHz | 2300 MHz-2400 MHz | TDD |
| n41 | 2496 MHz-2690 MHz | 2496 MHz-2690 MHz | TDD |
| n48 | 3550 MHz-3700 MHz | 3550 MHz-3700 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n65 | 1920 MHz-2010 MHz | 2110 MHz-2200 MHz | FDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n77 | 3300 MHz-4200 MHz | 3300 MHz-4200 MHz | TDD |
| n78 | 3300 MHz-3800 MHz | 3300 MHz-3800 MHz | TDD |
| n79 | 4400 MHz-5000 MHz | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |
| n86 | 1710 MHz-1780 MHz | N/A | SUL |
| [n90] | 2496 MHz-2690 MHz | 2496 MHz-2690 MHz | TDD |

TABLE 3

| | Uplink (UL) and Downlink | |
|---|---|---|
| | (DL)operating band | |
| | BS transmit/receive | |
| NR | UE transmit/receive | |
| operating | F_{UL, low}-F_{UL, high} | Duplex |
| band | F_{DL, low}-F_{DL, high} | Mode |
| n257 | 26500 MHz-29500 MHz | TDD |
| n258 | 24250 MHz-27500 MHz | TDD |
| n260 | 37000 MHz-40000 MHz | TDD |
| n261 | 27500 MHz-28350 MHz | TDD |

The number of LTE or 5G frequency bands and the level of signal enhancement can vary based on a particular wireless device, cellular node, or location. Additional domestic and international frequencies can also be included to offer increased functionality. Selected models of the signal booster 120 can be configured to operate with selected frequency bands based on the location of use. In another example, the signal booster 120 can automatically sense from the wireless device 110 or base station 130 (or GPS, etc.) which frequencies are used, which can be a benefit for international travelers.

In one configuration, multiple signal boosters can be used to amplify UL and DL signals. For example, a first signal booster can be used to amplify UL signals and a second signal booster can be used to amplify DL signals. In addition, different signal boosters can be used to amplify different frequency ranges.

In one configuration, the signal booster 120 can be configured to identify when the wireless device 110 receives a relatively strong downlink signal. An example of a strong downlink signal can be a downlink signal with a signal strength greater than approximately −80 dBm. The signal booster 120 can be configured to automatically turn off selected features, such as amplification, to conserve battery life. When the signal booster 120 senses that the wireless device 110 is receiving a relatively weak downlink signal, the integrated booster can be configured to provide amplification of the downlink signal. An example of a weak downlink signal can be a downlink signal with a signal strength less than −80 dBm.

In one example, the signal booster 120 can also include one or more of: a waterproof casing, a shock absorbent casing, a flip-cover, a wallet, or extra memory storage for the wireless device. In one example, extra memory storage can be achieved with a direct connection between the signal booster 120 and the wireless device 110. In another example, Near-Field Communications (NFC), Bluetooth v5.1, Bluetooth v5, Bluetooth v4.0, Bluetooth Low Energy, Bluetooth v4.1, Bluetooth v4.2, Bluetooth 5, Ultra High Frequency (UHF), 3GPP LTE, 3GPP 5G, Institute of Electronics and Electrical Engineers (IEEE) 802.11a, IEEE 802.11b, IEEE 802.11g, IEEE 802.11n, IEEE 802.11ac, or IEEE 802.11ad can be used to couple the signal booster 120 with the wireless device 110 to enable data from the wireless device 110 to be communicated to and stored in the extra memory storage that is integrated in the signal booster 120. Alternatively, a connector can be used to connect the wireless device 110 to the extra memory storage.

Mobile service providers are proposing to provide 5G-like services in the 600 MHz band. However, the 600 MHz band can require additional antenna elements (e.g., dipole elements) and/or a larger antenna to enable operation at this lower frequency band. In addition, the antenna elements share a center feed line, such that individual controls for impedance matching can be difficult to achieve over broad frequency bands.

With respect to past solutions, a bandwidth of an antenna (e.g., a log periodic dipole antenna) can be determined by a number of antenna elements (e.g., dipole elements) and a length of each of the antenna elements. Thus, a broader bandwidth can be achieved for the antenna by use of more antenna elements and longer antenna elements. However, one problem with increasing the number of antenna elements and the length of the antenna elements is the resulting increase in antenna area, particularly in width and length of the antenna. With an increase in both length and width, an antenna enclosure can have significantly greater surface area. When the antenna and enclosure are designed for portable use, such as on a moving vehicle, the size of the enclosure can result in an increased weight of the antenna and enclosure, and can also significantly aggravate the problem of wind loading. In particular, an antenna operating at the 600 MHz band or 700 MHz band (band 71 or band 21, respectively) can require a larger reflector and/or longer antenna elements, and therefore additional spacing resulting from the larger reflector and/or longer antenna elements can increase the overall size of the antenna and the antenna enclosure.

In one configuration, in order to increase the bandwidth and control impedance matching, protrusions or extended tabs can be added to one or more antenna elements in the antenna. As a result, the antenna elements with the protrusions or extended tabs can be referred to as “L-shaped” antenna elements. For example, antenna elements can be configured with protrusions or extended tabs. The element may be a unitary element. Alternatively, the protrusions or extended tabs can be added to extend the bandwidth of the antenna and achieve improved impedance matching at operating frequency bands. A loaded impedance can be changed by changing a width of the antenna element and by using a combination of different widths. The protrusions or extended tabs on the antenna elements can achieve a broader bandwidth for the antenna, while not necessarily increasing a total size of the antenna. In addition, the protrusions or extended tabs on the antenna elements can create additional current paths such that the bandwidth for the antenna becomes broader, as well as provide a stepped impedance to control antenna impedance matching.

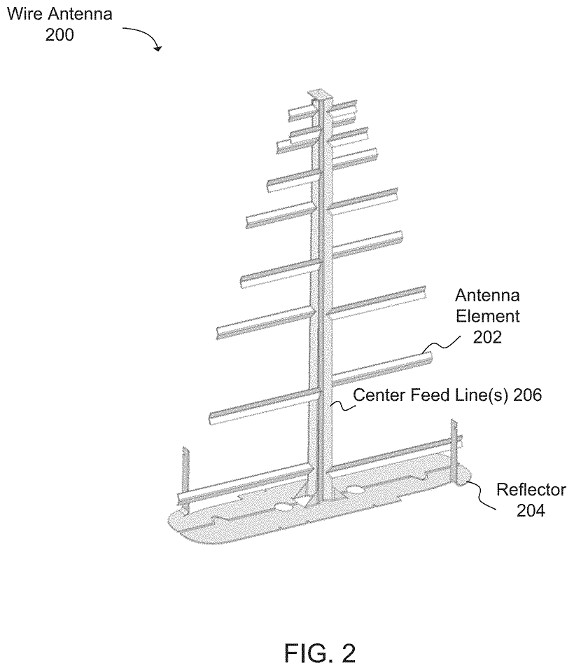

FIG. 2 illustrates an example of a traditional wire antenna 200 (e.g., a log periodic antenna or dipole antenna) with antenna element(s) 202 (e.g., dipole elements) that are carried by a center feed line 206 (e.g., a center feed line that includes a top center feed line and a bottom center feed line) of the wire antenna 200. The top center feed line and the bottom center feed line can have an alternating phase to enable operation as a dipole antenna. One dipole can be connected to the top center feed line and another dipole can be connected to a bottom center feed line. The antenna elements 202 can be conductive elements, such as a metal wires or rods. The dipole antenna 202 can be coupled to each side of the center feed line 206 (e.g., the antenna elements 202 can extend orthogonally from the center feed line 206). In this example, nine antenna elements 202 can be on each side of the center feed line 206, but a greater or lesser number of antenna elements 202 can be included. In addition, the wire antenna 200 can include a reflector 204 that is attached to the center feed line 206.

In one example, the antenna element 202 can be an electrical half wavelength long or a multiple of half wavelengths. A length of the antenna element 202 can be slightly shorter than the wavelength in free space. Thus, the length of the antenna element 202 can be slightly shorter than the length calculated for a wave traveling in free space, which can result due to the antenna normally operating surrounded by air, and the signal can be traveling in a conductor that is of finite length. For a high wave antenna element 202, the length for the wave traveling in free space can be calculated and can be multiplied by a factor “A”, which can typically be between 0.96 and 0.98 and can be dependent upon a ratio of the length of the antenna element 202 to a thickness of a wire or tube used for the antenna element 202. In one example, the length (in meters) of the antenna element 202 can be calculated using (150A/f), wherein f is a frequency.

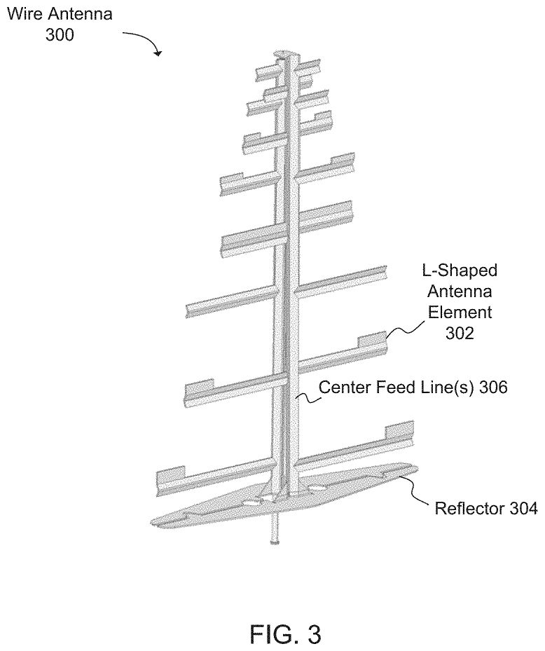

FIG. 3 illustrates an example of a wire antenna 300 (e.g., a log periodic dipole antenna or a dipole antenna) with L-shaped antenna element(s) 302 (e.g., L-shaped dipole elements) that are carried by a center feed line 306 of the wire antenna 300. The L-shaped antenna elements 302 can be on either side of the center feed line 306 (e.g., the L-shaped antenna elements 302 can extend orthogonally from the center feed line 306). The L-shaped antenna element 302 can enable the wire antenna 300 to operate at a low frequency range (relative to elements that are not L-shaped) while reducing an overall area of the wire antenna 300. The L-shaped antenna element 302 can provide additional current paths that operate to increase a defined operating frequency band of the L-shaped antenna element 302. For example, a wire antenna without an L-shaped antenna element 302 may operate over a frequency band of 700 Megahertz (MHz) to 960 MHz. A similarly sized wire antenna that included L-shaped antenna elements 302 may operate over a frequency range of 600 MHz to 960 MHz. The use of L-shaped antenna elements can allow the lower frequency range to be used without significantly increasing the size of the wire antenna. This will be discussed more fully in the proceeding paragraphs.

In one example, the wire antenna 300 can also include non-L-shaped antenna elements that are on each side of the center feed line 306. In this example, nine L-shaped/non-L-shaped antenna elements 302 can be on each side of the center feed line 306, but a greater or lesser number of L-shaped/non-L-shaped antenna elements 302 can be included in the wire antenna 300. In addition, the wire antenna 300 can include a reflector 304 that is attached to the center feed line 306.

Generally speaking, the antenna elements (L-shaped or non-L-shaped antenna elements) can be straight electrical conductors measuring ½ wavelength from end-to-end, and connected at a center to a radio frequency (RF) feed line (or center feed line). The antenna elements can be RF radiating and receiving elements for the wire antenna.

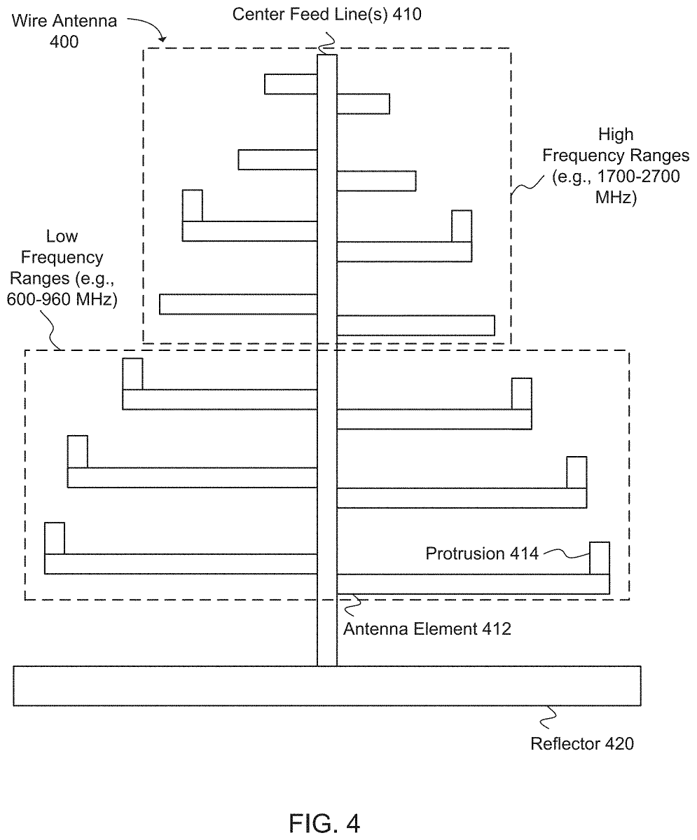

FIG. 4 illustrates an example of a wire antenna 400 (e.g., a log periodic antenna, a dipole antenna or a yagi-uda antenna) that includes a plurality of antenna elements including an antenna element 412. The wire antenna 400 can include a center feed line 410 that carries the plurality of antenna elements including the antenna element 412. The plurality of antenna elements can extend orthogonally from the center feed line 410. The center feed line 410 can be attached to a reflector 420 of the wire antenna 400, where the reflector 420 can function to reflect electromagnetic waves. In one example, the upper antenna elements included in the wire antenna 400 can be associated with high frequency ranges (e.g., 1700-2700 MHz), and the lower antenna elements included in the wire antenna 400 can be associated with low frequency ranges (e.g., 600-960 MHz). Each pair of antenna elements can be configured to radiate electromagnetic energy a specific radio frequency, with a return loss below a predetermined threshold over a selected frequency band.

In one configuration, the plurality of antenna elements can include antenna elements that include protrusions, such as the antenna element 412 having a protrusion 414, as well as antenna elements that do not include protrusions. In one example, the protrusions can form antenna elements with an L-shape. The protrusions can be a unitary design with the antenna element, formed of a single conductive element. Alternatively, the protrusion can be attached to or coupled to the antenna element. When the protrusion is attached to the antenna element, a relatively smooth attachment mechanism can be used to reduce eddy currents and other potential radiative elements. For example, a solder or conductive adhesive can be used to attach the protrusion to the antenna element.

The antenna element 412 with the protrusion 412 can enable the wire antenna 400 to operate at a low frequency range while reducing an overall area of the wire antenna 400. In addition, the antenna element 412 with the protrusion 412 can provide additional current paths for the antenna element 412, which can function to increase a defined operating frequency of the antenna element 412.

In this example, seven antenna elements with/without protrusions can be on each side of the center feed line 410, but a greater or lesser number of antenna elements with/without protrusions can be included in the wire antenna 400, depending on the frequency range that the wire antenna 400 is designed to operate at. In one example, the protrusion 414 can provide a broader bandwidth for the antenna element 412, thereby reducing an overall number of antenna elements to cover operating frequencies of the wire antenna 400. Thus, the protrusion 414 for the antenna element 412 can function to reduce an overall volume of the wire antenna 400.

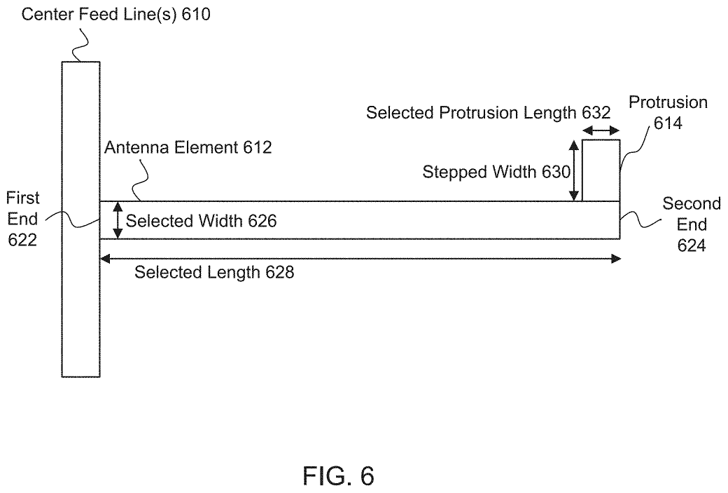

As a non-limiting example, on a first side, the wire antenna 400 can have antenna dimensions, as illustrated in FIG. 6, that include a first antenna element 612 having a selected length 628 of 94 millimeters (mm), a selected width 626 of 6.8 mm, a selected protrusion length 632 of 36.2 mm and a stepped width 630 of 6.99 mm. The wire antenna 400 can include a second antenna element having a selected length of 71.25 mm and a selected width of 6.8 mm with no protrusion 414. The wire antenna 400 can include a third antenna element having a selected length of 46.58 mm, a selected width of 6.8 mm, a selected protrusion length of 16.7 mm and a stepped width of 3.21 mm. The wire antenna 400 can include a fourth antenna element having a selected length of 27.22 mm and a selected width of 6.8 mm with no protrusion 414. The wire antenna 400 can include a fifth antenna element having a selected length of 20.93 mm and a selected width of 6.8 mm with no protrusion 414. On the opposite side of the wire antenna 400, the wire antenna 400 can include a sixth antenna element having a selected length of 50.89 mm, a selected width of 6.8 mm, a selected protrusion length of 20.5 mm and a stepped width of 5.89 mm. The wire antenna 400 can include a seventh antenna element having a selected length of 52.91 mm and a selected width of 6.8 mm with no protrusion 414. The wire antenna 400 can include an eighth antenna element having a selected length of 36.3 mm, a selected width of 6.8 mm, a selected protrusion length of 24.5 mm and a stepped width of 3.51 mm. The wire antenna 400 can include a ninth antenna element having a selected length of 20.47 mm and a selected width of 6.8 mm with no protrusion 414. In this example, the first antenna element, the second antenna element, the third antenna element, the fourth antenna element and the fifth antenna element can be on one side of the wire antenna 400, and the sixth antenna element, the seventh antenna element, the eight antenna element and the ninth antenna element can be on the opposite side of the wire antenna 400. In addition, the reflector 420 can have a length of 194.95 mm.

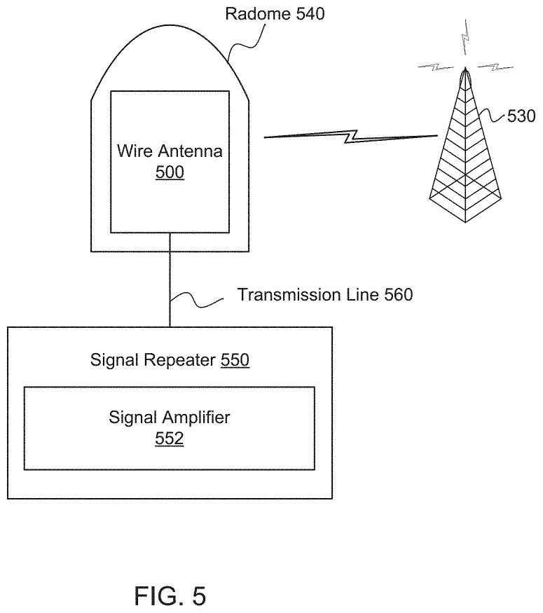

FIG. 5 illustrates an example of a repeater system that includes a wire antenna 500 (e.g., a log periodic antenna or a dipole antenna) communicatively coupled to a signal repeater 550 (or signal booster). The wire antenna 500 can be enclosed within a radome 540. The radome 540 can be a structural, weatherproof enclosure that protects the wire antenna 500. The radome 540 can be constructed of a material that minimally attenuates the electromagnetic signal transmitted or received by the wire antenna 500. The radome 540 can be constructed in various shapes, such as spherical, geodesic, planar, etc., and can use various construction materials, such as fiberglass, polytetrafluoroethylene (PTFE)-coated fabric, etc. For antennas designed for use in a mobile operation, such as attached to an exterior of a vehicle, the radome can be constructed to have a fluid shape to minimize air drag.

In one configuration, the wire antenna 500 can be communicatively coupled, via a transmission line 560 such as a coaxial cable, to a signal repeater 550 that includes a signal amplifier 552. The signal amplifier 552 can be a bidirectional repeater that is configured to amplify and filter uplink and downlink signals. For example, the wire antenna 500 can receive an uplink signal from a mobile device (not shown), and the uplink signal can be provided to the signal amplifier 552 via a server antenna (not shown). The signal amplifier 552 can amplify and filter the uplink signal, and provide the amplified and filtered uplink signal to the wire antenna 500. The wire antenna 500 can transmit the amplified and filtered uplink signal to a base station 530. In another example, the wire antenna 500 can receive a downlink signal from the base station 530, and provide the downlink signal to the signal amplifier 552. The signal amplifier 552 can amplify and filter the downlink signal, and provide the amplified and filtered downlink signal to the server antenna. The server antenna can transmit the amplified and filtered downlink signal to the mobile device.

In one configuration, the wire antenna 500 and the signal repeater 550 can be installed in a building or stadium, or in a vehicle. For example, the wire antenna 500 can be a donor antenna configured to be installed on the exterior of a vehicle.

In one configuration, the wire antenna 500 can be used to communicate with a mobile device (i.e. operating as a server antenna) or to communicate with a base station (i.e. operating as a donor antenna).

FIG. 6 illustrates an example of an antenna element 612 with a protrusion 614. The antenna element 612 can be one of a plurality of antenna elements included in a wire antenna (e.g., log periodic antenna or dipole antenna). The antenna element 612 can be carried by or attached to a center feed line 610 of the wire antenna. The antenna element 612 can have a selected length 628 and a selected width 626. The antenna element 612 can include a first end 622 that is carried by the center feed line 610 and a second end 624 that is disposed distally from the center feed line 610. In other words, the first end 622 of the antenna element 612 can be adjacent to the center feed line 610 and the second end 624 of the antenna element 612 can be adjacent to the protrusion 614.

In one example, the protrusion 614 can have a stepped width 630 and a selected protrusion length 632. In other words, the protrusion 614 can have the stepped width 630 over the selected protrusion length 632. The protrusion 614 can be located proximate to the second end 624 of the antenna element 612. The stepped width 630 can be an approximately 90-degree step, which can cause the antenna element 612 to form an L-shaped antenna element. The selected width 626 and selected length 628 of the antenna element 612, and the stepped width 630 and selected protrusion length 632 of the protrusion 614 can be selected to enable the wire antenna to operate at a selected frequency or frequency range. The selected frequency or frequency range can be a lower frequency range relative to an antenna element without a protrusion with a similar selected length 628, thereby reducing an area of the wire antenna.

In one example, the stepped width 630 and the selected protrusion length 632 can be determined using a simulation application or program based on a finite element technique or another type of simulation. The simulation can be used to determine a protrusion length 632 and a stepped width 630 to provide a desired antenna gain over a selected bandwidth, while allowing the antenna to have predetermined size constraints. For example, an antenna may have size constraints to fit within a selected radome size or shape.

In one example, the stepped width 630 and the selected protrusion length 632 can be different for different protrusions 614, depending on the frequency. For example, a first protrusion for a low band antenna element can have a different selected protrusion length and a different stepped width as compared to a second protrusion for a high band antenna element. Each stepped width 630 and selected protrusion length 632 can determine a reactance (inductance and capacitance) of the wire antenna. Since the reactance can also depend on the frequency, the stepped width 630 and the selected protrusion length 632 can be determined based on the frequency.

In one example, the protrusion 614 can have a stepped width 630 that is greater than the selected width 626 of the antenna element 612, or alternatively, the protrusion 614 can have the stepped width 630 that is less than the selected width 626 of the antenna element 612. In another example, the protrusion 614 can have a selected protrusion length 632 that is less than the selected length 628 of the antenna element 612. As non-limiting examples, the protrusion 614 can have the selected protrusion length 632 that is 5%, 10%, 20%, 30%, 40%, 50%, 60%, 70%, 80%, or 90% of the selected length 628 of the antenna element 612. In addition, the stepped width 630 of the protrusion 614 and the selected protrusion length 632 can be selected to provide a predetermined impedance for the antenna element 612 having the protrusion 614 that is configured to operate at a selected frequency range.

In one configuration, the stepped width 630 of the protrusion 614 and the selected protrusion length 632 can be selected accordingly to provide additional current paths for the antenna element 612, thereby increasing a defined operating frequency of the antenna element 612. The stepped width 630 and/or the selected protrusion length 632 can be increased to provide further additional current paths and increase the defined operating frequency of the antenna element 612. The stepped width 630 of the protrusion 614 and the selected protrusion length 632 can be selected accordingly to enable the wire antenna to operate at a low frequency range while reducing an overall area and/or volume of the wire antenna. In addition, the stepped width 630 of the protrusion 614 and the selected protrusion length 632 can be selected accordingly to provide a broader bandwidth for the antenna element 612, thereby reducing an overall number of antenna elements to cover operating frequencies of the wire antenna.

In one example, the antenna element 612 can operate at a low frequency range, e.g., between 600 MHz and 960 MHz. In another example, the dipole 612 can operate at a high frequency range, e.g., between 1700 MHz and 2700 MHz. Whether the antenna element 612 operates in the low frequency range or the high frequency range is dependent on the selected width 626, selected length 628, selected protrusion length 632, and stepped width 630. In one example, the antenna elements can be carried by the center feed line 610 in ascending order based on the selected length. For example, the antenna element 612 can have a longer selected length and/or stepped width, selected protrusion length 632, or selected width 626 to operate in the low frequency range and be located as one of the lower antenna elements. Alternatively, the antenna element can have a shorter selected length 628 and/or stepped width, selected protrusion length 632, or selected width 626 and operate in the high frequency range as one of the upper antenna elements.

In one example, the antenna element can be formed from a first piece of material and the protrusion 614 can be formed from a second piece of the material and attached proximate to the second end 624 of the antenna element 612. In other words, the protrusion 614 can be a separate piece of material attached to the antenna element 612. Alternatively, the protrusion 614 and the antenna element 612 can be formed of a unitary single piece of material.

In one configuration, the antenna can be configured as a monopole antenna that includes an antenna element. The antenna element can have a selected length and a selected width. A first end of the monopole antenna can be at a conductive ground and a second end of the monopole antenna can be disposed distally from the conductive ground. The antenna element can include a protrusion with a stepped width, over a selected length, where the protrusion is located proximate to the second end of the antenna element. The protrusion can have the stepped width that is greater than the selected width of the antenna element. In addition, the protrusion can enable the monopole antenna to operate at a desired frequency range while reducing an area of the wire antenna.

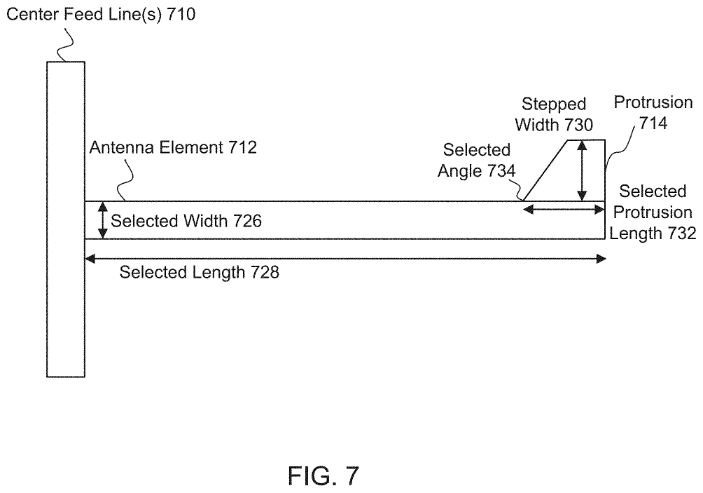

FIG. 7 illustrates an example of an antenna element 712 with a protrusion 714. The antenna element 712 can be one of a plurality of antenna elements included in a wire antenna (e.g., a dipole antenna or a log periodic antenna). The antenna element 712 can be carried by or attached to a center feed line 710 of the wire antenna. The antenna element 712 can have a selected length 728 and a selected width 726. In one example, the protrusion 714 can have a stepped width 730 having an increase in width, over a selected protrusion length 732, from the selected width 726 of the antenna element 712 to the stepped width 730 of the protrusion 714. The increase in width for the protrusion 714 can be in accordance with a selected angle 734 that is greater than or equal to 45 degrees. The selected angle 734 can be determined based on a desired antenna impedance to provide a selected antenna radiation pattern. In an alternative example, the protrusion 714 can have a tapered stepped width to form an L-shaped antenna element.

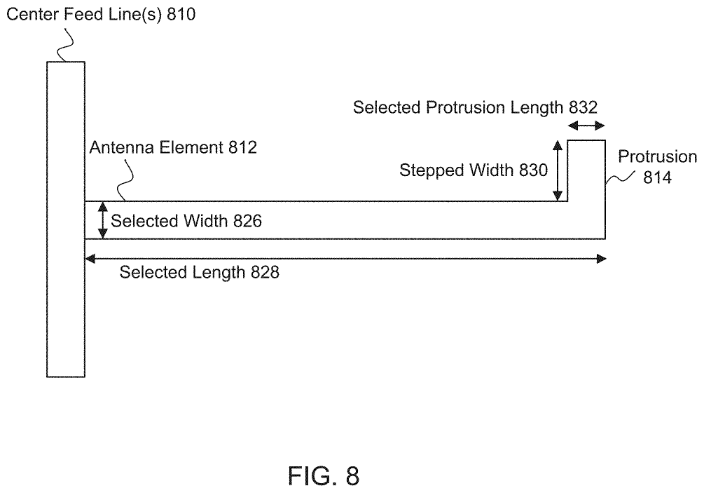

FIG. 8 illustrates an example of an antenna element 812 with a protrusion 814. The antenna element 812 can be one of a plurality of antenna elements included in a wire antenna (e.g., a dipole antenna or a log periodic antenna). The antenna element 812 can be carried by or attached to a center feed line 810 of the wire antenna. The antenna element 812 can have a selected length 828 and a selected width 826. The protrusion 814 can have a stepped width 830 and a selected protrusion length 832. In this configuration, the antenna element 812 and the protrusion 814 can be a unitary piece of material, as opposed to the protrusion 814 being a separate piece of material attached to the antenna element 812.

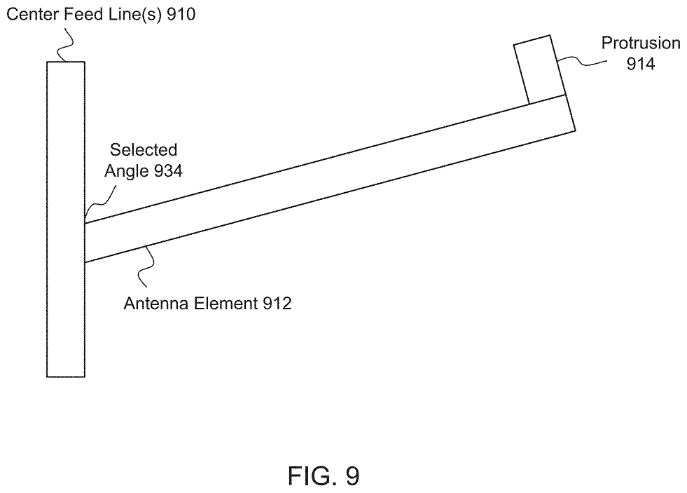

FIG. 9 illustrates an example of an antenna element 912 with a protrusion 914. The antenna element 912 can be one of a plurality of antenna elements included in a wire antenna (e.g., a dipole antenna or a log periodic antenna). The antenna element 912 can be carried by or attached to a center feed line 910 of the wire antenna. In this configuration, the antenna element 912 can extend from the center feed line 910 at a selected angle 934 relative to the center feed line 910. In other words, the antenna element 912 can extend from the center feed line 910 at the selected angle 934 (e.g., greater than or less than 90 degrees), as opposed to the antenna element 912 extending orthogonally or approximately at 90 degrees from the center feed line 910.

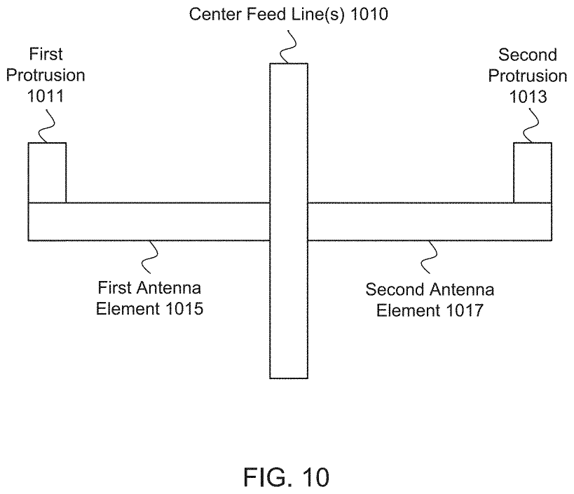

FIG. 10 illustrates an example of a first antenna element 1015 and a second antenna element 1017 included in a wire antenna (e.g., a dipole antenna or a log periodic antenna). The first antenna element 1015 and the second antenna element 1017 can be carried by a center feed line 1010 of the wire antenna. The first antenna element 1015 can include a first protrusion 1011 and the second antenna element 1017 can include a second protrusion 1013. In this configuration, the first antenna element 1015 can be located directly across the center feed line 1010 from the second antenna element 1017. In other words, the first antenna element 1015 and the second antenna element 1017 can be aligned.

In one example, the first protrusion 1011 and the second protrusion 1013 of the aligned antenna elements 1015 and 1017, respectively, can have a same size (i.e. a same angle, a same stepped width and a same selected protrusion length). Alternatively, the first protrusion 1011 and the second protrusion 1013 of the offset antenna elements 1015 and 1017 can have a different size, with one or more of a different angle, a different stepped width, and/or a different selected protrusion length. Using protrusions with the same size can provide an antenna radiation pattern that is symmetrical. Using protrusions that have a different size can provide a non-symmetrical radiation pattern.

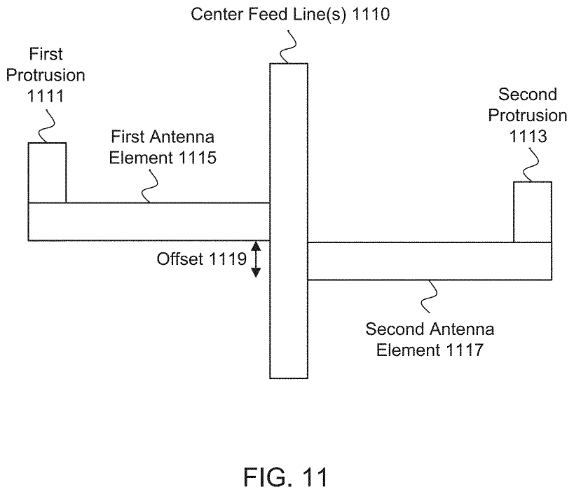

FIG. 11 illustrates an example of a first antenna element 1115 and a second antenna element 1117 included in a wire antenna (e.g., a dipole antenna or a log periodic antenna). The first antenna element 1115 and the second antenna element 1117 can be attached to or carried by a center feed line 1110 of the wire antenna. The first antenna element 1115 can include a first protrusion 1111 and the second antenna element 1117 can include a second protrusion 1113. In this configuration, the first antenna element 1115 can be located across the center feed line 1110 from the second antenna element 1117 in accordance with an offset 1119. In other words, in this configuration, the first antenna element 1115 and the second antenna element 1117 can be misaligned in accordance with the offset 1119, as opposed to the first antenna element 1115 being directly across from the second antenna element 1117, as illustrated in FIG. 10.

In one example, the first protrusion 1111 and the second protrusion 1113 of the offset antenna elements 1115 and 1117, respectively, can have a same size (i.e. a same angle, a same stepped width and a same selected protrusion length). Alternatively, the first protrusion 1111 and the second protrusion 1113 of the offset antenna elements 1115 and 1117 can have a different size, with one or more of a different angle, a different stepped width, and/or a different selected protrusion length. Using protrusions with the same size can provide an antenna radiation pattern that is symmetrical. Using protrusions that have a different size can provide a non-symmetrical radiation pattern.

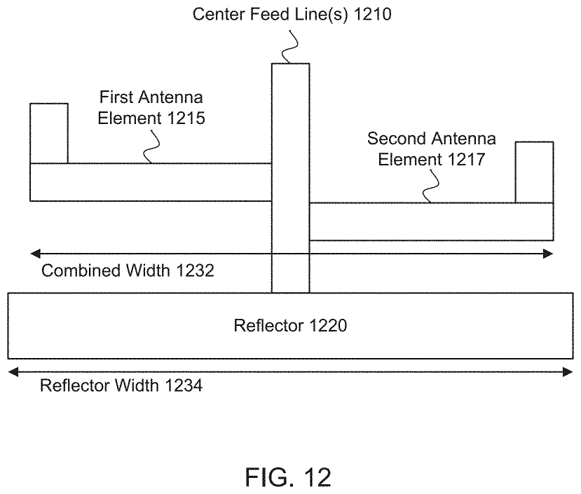

FIG. 12 illustrates an example of a reflector 1220 included in a wire antenna (e.g., a log periodic antenna or dipole antenna). The reflector 1220 can be carried by or attached to a center feed line 1210 of the wire antenna. The reflector 1220 can be located adjacent to a first antenna element 1215 and/or a second antenna element 1217, where the first antenna element 1215 and/or the second antenna element 1217 can have a greatest selected length of a plurality of antenna elements included in the wire antenna. In other words, the reflector 1220 can be at the bottom of the wire antenna and the first antenna element 1215 and/or the second antenna element 1217 can be the lower most antenna elements in the wire antenna that are directly adjacent to the reflector 1220.

In one example, a combined width 1232 of the first antenna element 1215 and the second antenna element 1217 (including a width of the center feed line 1210) can be less than or equal to a reflector width 1234 of the reflector 1220. In other words, the reflector 1220 can have the reflector width 1234 that is equal to or greater than the combined width 1232 of the first antenna element 1215 and the second antenna element 1217 (which have the greatest selected lengths of the plurality of antenna elements included in the wire antenna).

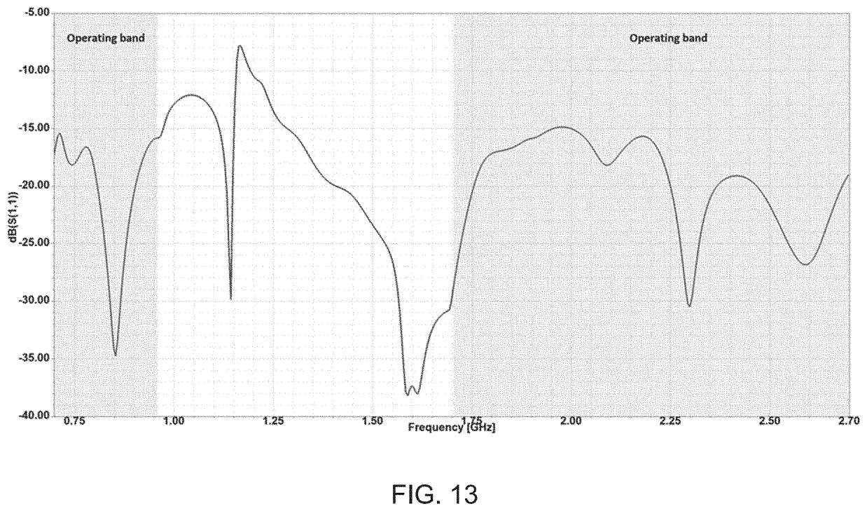

FIG. 13 illustrates an example of return loss of a wire antenna (e.g., a log periodic antenna or dipole antenna) with antenna elements having protrusions (or extended tabs). The return loss shows the amount of power reflected from the antenna. The reflected power is expressed in decibels (dB) over a frequency range (in GHz), which corresponds to a frequency range that includes the operating band(s) or operating frequency(s) for the wire antenna. In this example, the operating frequencies can be 700 MHz to 950 MHz, and 1700 MHz to 2700 MHz. In addition, the wire antenna can have a favorable impedance matching over the operating band(s) or operating frequency(s) for the wire antenna to provide a return loss of greater than −15 dB over the operating frequency range. Minimum return loss can occur at the frequency at which a selected antenna element of the antenna is designed to radiate.

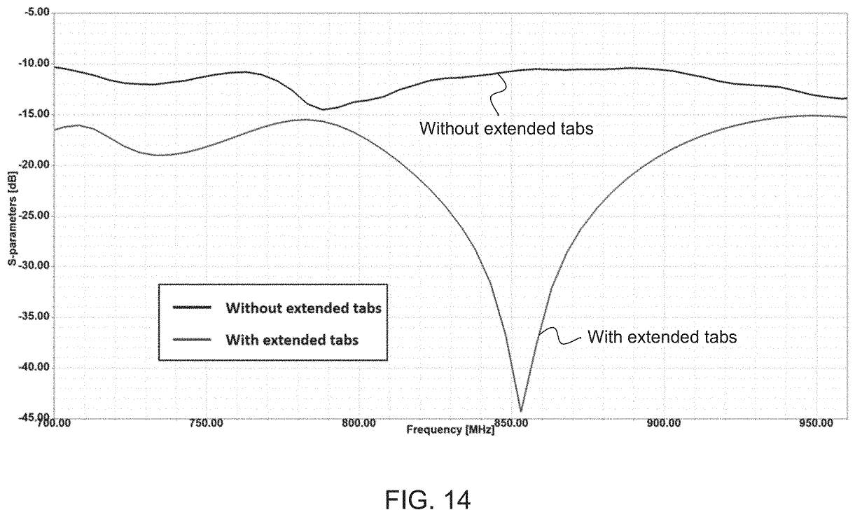

FIG. 14 illustrates an example of a return loss comparison between a wire antenna (e.g., a log periodic antenna or dipole antenna) with antenna elements having protrusions (or extended tabs) and a wire antenna with antenna elements not having protrusions. The return loss can be expressed in decibels (dB) over a frequency range (in GHz), which corresponds to operating band(s) or operating frequency(s) for the wire antenna. In this example, the operating frequency can be a low frequency range, such as 698-960 MHz. As shown, the return loss when the antenna elements have protrusions can be more favorable as compared to the return loss when the antenna elements do not have protrusions. The lower return loss of the wire antenna with protrusions enables greater signal power to be radiated over the operating frequency range of the antenna relative to the dipole antenna with no protrusions.

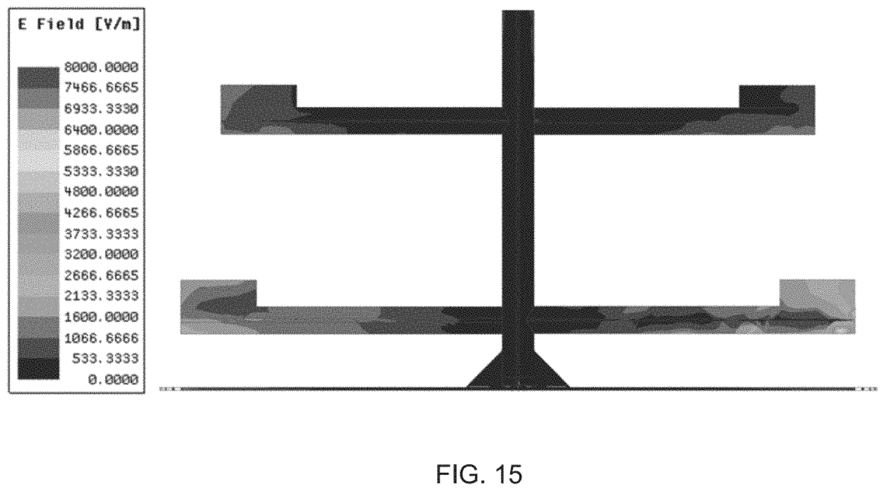

FIG. 15 illustrates an example of an electric field distribution for a wire antenna having a plurality of antenna elements. In this example, the wire antenna can have two sets of antenna elements, each having a protrusion (or extended tab). The electric field (or E-field) can be expressed as volts per meter (V/m). In this example, the electric field can become greater towards an end of each antenna element having the protrusion. In other words, the electric field distribution for the wire antenna can be such that an electric field can be greater at the antenna element's protrusion as compared to the antenna element's opposite end (adjacent to a center feed line).

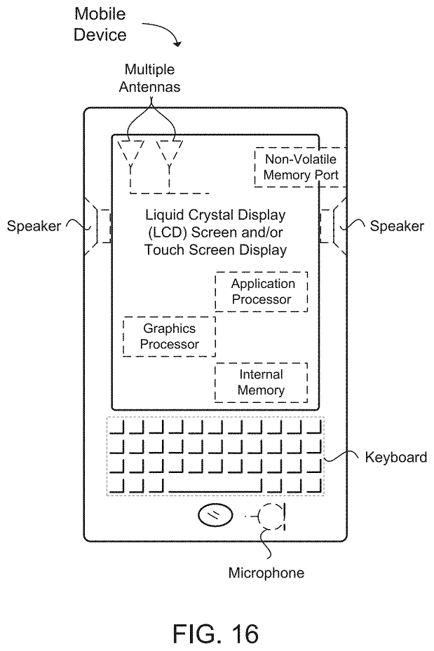

FIG. 16 provides an example illustration of the wireless device, such as a user equipment (UE), a mobile station (MS), a mobile communication device, a tablet, a handset, a wireless transceiver coupled to a processor, or other type of wireless device. The wireless device can include one or more antennas configured to communicate with a node or transmission station, such as an access point (AP), a base station (BS), an evolved Node B (eNB), a baseband unit (BBU), a remote radio head (RRH), a remote radio equipment (RRE), a relay station (RS), a radio equipment (RE), a remote radio unit (RRU), a central processing module (CPM), or other type of wireless wide area network (WWAN) access point. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

FIG. 16 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes a wire antenna, comprising: a center feed line that includes a top center feed line and a bottom center feed line; a plurality of antenna elements carried by the center feed line, wherein an antenna element in the plurality of antenna elements has a selected length and a selected width with a first end of the antenna element carried by the top center feed line and a second end of the antenna element is disposed distally from the bottom center feed line, wherein two or more antenna elements of the plurality of antenna elements each include a protrusion with a stepped width, over a selected length, the protrusion located proximate to the second end of the antenna element, the protrusion having the stepped width that is greater than the selected width of the antenna element; and a reflector carried by the center feed line and located adjacent to an antenna element having a greatest selected length of the plurality of antenna elements, wherein the two or more antenna elements having the protrusion enables the wire antenna to operate at a desired frequency range while reducing an area of the wire antenna.

Example 2 includes the wire antenna of Example 1, wherein the wire antenna is used for one of: a mobile device, a base station, a stadium, a vehicle or a building.

Example 3 includes the wire antenna of any of Examples 1 to 2, further comprising a radome configured to enclose the wire antenna.

Example 4 includes the wire antenna of any of Examples 1 to 3, wherein the plurality of antenna elements extend orthogonally from the center feed line.

Example 5 includes the wire antenna of any of Examples 1 to 4, wherein the top center feed line and the bottom center feed line are placed in parallel to have an alternating phase, and each antenna element in the plurality of antenna elements is connected to the top center feed line and the bottom center feed line.

Example 6 includes the wire antenna of any of Examples 1 to 5, wherein the plurality of antenna elements extend from the center feed line at a selected angle relative to the center feed line.

Example 7 includes the wire antenna of any of Examples 1 to 6, wherein the protrusion has a stepped width with an approximately 90-degree step to form an L-shaped antenna element.

Example 8 includes the wire antenna of any of Examples 1 to 7, wherein the protrusion has a tapered stepped width to form an L-shaped antenna element.

Example 9 includes the wire antenna of any of Examples 1 to 8, wherein the protrusion has a stepped width with an increase in width, over a predetermined length, from the selected width of the antenna element to the stepped width of the protrusion, at a selected angle that is greater than 45 degrees, wherein the selected angle is determined from an antenna impedance.

Example 10 includes the wire antenna of any of Examples 1 to 9, wherein the antenna element and the protrusion are formed from a unitary piece of material.

Example 11 includes the wire antenna of any of Examples 1 to 10, wherein the protrusion is a second piece of material attached proximate to the second end of the antenna element.

Example 12 includes the wire antenna of any of Examples 1 to 11, wherein the two or more antenna elements include a first antenna element that is connected to the top center feed line and a second antenna element that is connected to the bottom center feed line.

Example 13 includes the wire antenna of any of Examples 1 to 12, wherein the two or more antenna elements includes a first antenna element that is offset from a second antenna element at the center feed line by a selected distance.

Example 14 includes the wire antenna of any of Examples 1 to 13, wherein the wire antenna is configured to be communicatively coupled to a repeater.

Example 15 includes the wire antenna of any of Examples 1 to 14, wherein the reflector has a width equal to or greater than a combined width of two or more antenna elements having the greatest selected length of the plurality of antenna elements.

Example 16 includes the wire antenna of any of Examples 1 to 15, wherein the protrusion has a width and a length that is selected to provide a predetermined impedance for the antenna element having the protrusion that is configured to operate at a selected frequency range.

Example 17 includes the wire antenna of any of Examples 1 to 16, wherein the protrusion is configured to provide additional current paths in each of the two or more antenna elements having the protrusion, wherein the additional current paths operate to increase a defined operating frequency of the two or more antenna elements.

Example 18 includes the wire antenna of any of Examples 1 to 17, wherein the wire antenna is one of: a dipole antenna, a log periodic antenna, a monopole antenna, or a yagi-uda antenna.

Example 19 includes the wire antenna of any of Examples 1 to 18, wherein the frequency range is associated with a low frequency range between 600 megahertz (MHz) and 960 MHz.

Example 20 includes the wire antenna of any of Examples 1 to 19, wherein the frequency range is associated with a high frequency range between 1700 megahertz (MHz) and 2700 MHz.

Example 21 includes the wire antenna of any of Examples 1 to 20, wherein the two or more antenna elements of the plurality of antenna elements each include the protrusion with the stepped width to reduce a volume of the dipole antenna.

Example 22 includes the wire antenna of any of Examples 1 to 21, wherein the two or more antenna elements of the plurality of antenna elements each include the protrusion with the stepped width to provide a broader bandwidth and reduce a number of antenna elements to cover operating frequencies of the wire antenna.

Example 23 includes a repeater system, comprising: one or more amplification and filtering signal paths; and a wire antenna configured to be communicatively coupled to the one or more amplification and filtering signal paths, the wire antenna comprising: a center feed line that includes a top center feed line and a bottom center feed line; and a plurality of antenna elements carried by the center feed line, wherein a wire element in the plurality of antenna elements has a selected length and a selected width with a first end of the antenna element carried by the top center feed line and a second end of the antenna element is disposed distally from the bottom center feed line, wherein two or more antenna elements of the plurality of antenna elements each include a protrusion with a stepped width, over a selected length, the protrusion located proximate to the second end of the antenna element, the protrusion having the stepped width that is greater than the selected width of the antenna element.

Example 24 includes the repeater system of Example 23, wherein the two or more antenna elements having the protrusion enables the wire antenna to operate at a frequency range while reducing an area of the wire antenna.

Example 25 includes the repeater system of any of Examples 23 to 24, wherein the wire antenna further comprises a reflector carried by the center feed line and located adjacent to an antenna element having a greatest selected length of the plurality of antenna elements, wherein the reflector has a width equal to or greater than a combined width of two or more antenna elements having the greatest selected length of the plurality of antenna elements.

Example 26 includes the repeater system of any of Examples 23 to 25, wherein the plurality of antenna elements extend orthogonally from the center feed line.

Example 27 includes the repeater system of any of Examples 23 to 26, wherein the antenna element and the protrusion are formed from a unitary piece of material.

Example 28 includes the repeater system of any of Examples 23 to 27, wherein the protrusion is a second piece of material attached proximate to the second end of the antenna element.

Example 29 includes the repeater system of any of Examples 23 to 28, wherein the protrusion has a width and a length that is selected to provide a predetermined impedance for the antenna element having the protrusion that is configured to operate at a selected frequency range.

Example 30 includes the repeater system of any of Examples 23 to 29, wherein the protrusion is configured to provide additional current paths in each of the two or more antenna elements having the protrusion, wherein the additional current paths operate to increase a defined operating frequency of the two or more antenna elements.

Example 31 includes the repeater system of any of Examples 23 to 30, wherein the wire antenna is a log periodic antenna or a dipole antenna.

Example 32 includes an antenna, comprising: a center feed line that includes a top center feed line and a bottom center feed line; a plurality of antenna elements carried by the center feed line, wherein an antenna element in the plurality of antenna elements has a selected length and a selected width with a first end of the antenna element carried by the top center feed line and a second end of the antenna element is disposed distally from the bottom center feed line, wherein two or more antenna elements of the plurality of antenna elements each include a protrusion with a stepped width, over a selected length, the protrusion located proximate to the second end of the antenna element, the protrusion having the stepped width that is greater than the selected width of the antenna element; and a reflector carried by the center feed line and located adjacent to an antenna element having a greatest selected length of the plurality of antenna elements, wherein the two or more antenna elements having the protrusion enables the antenna to operate at a frequency range while reducing an area of the antenna.

Example 33 includes the antenna of Example 32, wherein the antenna is one of: a log periodic antenna, a dipole antenna, a monopole antenna, or a yagi-uda antenna.

Example 34 includes the antenna of any of Examples 32 to 33, wherein the plurality of antenna elements extends orthogonally from the center feed line.

Example 35 includes the antenna of any of Examples 32 to 34, wherein the protrusion has a stepped width with an approximately 90-degree step to form an L-shaped antenna element.

Example 36 includes the antenna of any of Examples 32 to 35, wherein the antenna is configured to be communicatively coupled to a signal booster.

Example 37 includes the antenna of any of Examples 32 to 36, wherein the protrusion is configured to provide additional current paths in each of the two or more antenna elements having the protrusion, wherein the additional current paths operate to increase a defined operating frequency of the two or more antenna elements.

Various techniques, or certain aspects or portions thereof, can take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a random-access memory (RAM), erasable programmable read only memory (EPROM), flash drive, optical drive, magnetic hard drive, solid state drive, or other medium for storing electronic data. One or more programs that can implement or utilize the various techniques described herein can use an application programming interface (API), reusable controls, and the like. Such programs can be implemented in a high level procedural or object oriented programming language to communicate with a computer system. However, the program(s) can be implemented in assembly or machine language, if desired. In any case, the language can be a compiled or interpreted language, and combined with hardware implementations.

As used herein, the term processor can include general purpose processors, specialized processors such as VLSI, FPGAs, or other types of specialized processors, as well as base band processors used in transceivers to send, receive, and process wireless communications.

It should be understood that many of the functional units described in this specification have been labeled as modules, in order to more particularly emphasize their implementation independence. For example, a module can be implemented as a hardware circuit comprising custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

In one example, multiple hardware circuits or multiple processors can be used to implement the functional units described in this specification. For example, a first hardware circuit or a first processor can be used to perform processing operations and a second hardware circuit or a second processor (e.g., a transceiver or a baseband processor) can be used to communicate with other entities. The first hardware circuit and the second hardware circuit can be incorporated into a single hardware circuit, or alternatively, the first hardware circuit and the second hardware circuit can be separate hardware circuits.

Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network. The modules can be passive or active, including agents operable to perform desired functions.

Reference throughout this specification to “an example” or “exemplary” means that a particular feature, structure, or characteristic described in connection with the example is included in at least one embodiment of the present invention. Thus, appearances of the phrases “in an example” or the word “exemplary” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention can be referred to herein along with alternatives for the various components thereof. It is understood that such embodiments, examples, and alternatives are not to be construed as defacto equivalents of one another, but are to be considered as separate and autonomous representations of the present invention.

Furthermore, the described features, structures, or characteristics can be combined in any suitable manner in one or more embodiments. In the following description, numerous specific details are provided, such as examples of layouts, distances, network examples, etc., to provide a thorough understanding of embodiments of the invention. One skilled in the relevant art will recognize, however, that the invention can be practiced without one or more of the specific details, or with other methods, components, layouts, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A wire antenna, comprising:
a center feed line that includes a top center feed line and a bottom center feed line;
a plurality of antenna elements carried by the center feed line,
wherein an antenna element in the plurality of antenna elements has a selected length and a selected width with a first end of the antenna element carried by the top center feed line and a second end of the antenna element is disposed distally from the bottom center feed line,
wherein two or more antenna elements of the plurality of antenna elements each include a protrusion with a stepped width, over a selected length, the protrusion located proximate to the second end of the antenna element, the protrusion having the stepped width that is greater than the selected width of the antenna element; and
a reflector carried by the center feed line and located adjacent to an antenna element having a greatest selected length of the plurality of antenna elements,
wherein the two or more antenna elements having the protrusion enables the wire antenna to operate at a desired frequency range while reducing an area of the wire antenna.

2. The wire antenna of claim 1, wherein the wire antenna is used for one of: a mobile device, a base station, a stadium, a vehicle or a building.

3. The wire antenna of claim 1, further comprising a radome configured to enclose the wire antenna.

4. The wire antenna of claim 1, wherein the plurality of antenna elements extend orthogonally from the center feed line.

5. The wire antenna of claim 1, wherein the top center feed line and the bottom center feed line are placed in parallel to have an alternating phase, and each antenna element in the plurality of antenna elements is connected to the top center feed line and the bottom center feed line.

6. The wire antenna of claim 1, wherein the plurality of antenna elements extend from the center feed line at a selected angle relative to the center feed line.

7. The wire antenna of claim 1, wherein the protrusion has a stepped width with an approximately 90-degree step to form an L-shaped antenna element.

8. The wire antenna of claim 1, wherein the protrusion has a tapered stepped width to form an L-shaped antenna element.

9. The wire antenna of claim 1, wherein the protrusion has a stepped width with an increase in width, over a predetermined length, from the selected width of the antenna element to the stepped width of the protrusion, at a selected angle that is greater than 45 degrees, wherein the selected angle is determined from an antenna impedance.

10. The wire antenna of claim 1, wherein the antenna element and the protrusion are formed from a unitary piece of material.

11. The wire antenna of claim 1, wherein the protrusion is a second piece of material attached proximate to the second end of the antenna element.

12. The wire antenna of claim 1, wherein the two or more antenna elements include a first antenna element that is connected to the top center feed line and a second antenna element that is connected to the bottom center feed line.

13. The wire antenna of claim 1, wherein the two or more antenna elements includes a first antenna element that is offset from a second antenna element at the center feed line by a selected distance.

14. The wire antenna of claim 1, wherein the wire antenna is configured to be communicatively coupled to a repeater.

15. The wire antenna of claim 1, wherein the reflector has a width equal to or greater than a combined width of two or more antenna elements having the greatest selected length of the plurality of antenna elements.

16. The wire antenna of claim 1, wherein the protrusion has a width and a length that is selected to provide a predetermined impedance for the antenna element having the protrusion that is configured to operate at a selected frequency range.

17. The wire antenna of claim 1, wherein the protrusion is configured to provide additional current paths in each of the two or more antenna elements having the protrusion, wherein the additional current paths operate to increase a defined operating frequency of the two or more antenna elements.

18. The wire antenna of claim 1, wherein the wire antenna is one of: a dipole antenna, a log periodic antenna, a monopole antenna, or a yagi-uda antenna.

19. The wire antenna of claim 1, wherein the frequency range is associated with a low frequency range between 600 megahertz (MHz) and 960 MHz.

20. The wire antenna of claim 1, wherein the frequency range is associated with a high frequency range between 1700 megahertz (MHz) and 2700 MHz.

21. The wire antenna of claim 1, wherein the two or more antenna elements of the plurality of antenna elements each include the protrusion with the stepped width to reduce a volume of the dipole antenna.

22. The wire antenna of claim 1, wherein the two or more antenna elements of the plurality of antenna elements each include the protrusion with the stepped width to provide a broader bandwidth and reduce a number of antenna elements to cover operating frequencies of the wire antenna.

23. A repeater system, comprising:
one or more amplification and filtering signal paths; and
a wire antenna configured to be communicatively coupled to the one or more amplification and filtering signal paths, the wire antenna comprising:
a center feed line that includes a top center feed line and a bottom center feed line; and
a plurality of antenna elements carried by the center feed line,
wherein a wire element in the plurality of antenna elements has a selected length and a selected width with a first end of the antenna element carried by the top center feed line and a second end of the antenna element is disposed distally from the bottom center feed line,
wherein two or more antenna elements of the plurality of antenna elements each include a protrusion with a stepped width, over a selected length, the protrusion located proximate to the second end of the antenna element, the protrusion having the stepped width that is greater than the selected width of the antenna element.

24. The repeater system of claim 23, wherein the two or more antenna elements having the protrusion enables the wire antenna to operate at a frequency range while reducing an area of the wire antenna.

25. The repeater system of claim 23, wherein the wire antenna further comprises a reflector carried by the center feed line and located adjacent to an antenna element having a greatest selected length of the plurality of antenna elements, wherein the reflector has a width equal to or greater than a combined width of two or more antenna elements having the greatest selected length of the plurality of antenna elements.

26. The repeater system of claim 23, wherein the plurality of antenna elements extend orthogonally from the center feed line.

27. The repeater system of claim 23, wherein the antenna element and the protrusion are formed from a unitary piece of material.

28. The repeater system of claim 23, wherein the protrusion is a second piece of material attached proximate to the second end of the antenna element.

29. The repeater system of claim 23, wherein the protrusion has a width and a length that is selected to provide a predetermined impedance for the antenna element having the protrusion that is configured to operate at a selected frequency range.

30. The repeater system of claim 23, wherein the protrusion is configured to provide additional current paths in each of the two or more antenna elements having the protrusion, wherein the additional current paths operate to increase a defined operating frequency of the two or more antenna elements.

31. The repeater system of claim 23, wherein the wire antenna is a log periodic antenna or a dipole antenna.

32. An antenna, comprising:
a center feed line that includes a top center feed line and a bottom center feed line;
a plurality of antenna elements carried by the center feed line,
wherein an antenna element in the plurality of antenna elements has a selected length and a selected width with a first end of the antenna element carried by the top center feed line and a second end of the antenna element is disposed distally from the bottom center feed line,
wherein two or more antenna elements of the plurality of antenna elements each include a protrusion with a stepped width, over a selected length, the protrusion located proximate to the second end of the antenna element, the protrusion having the stepped width that is greater than the selected width of the antenna element; and
a reflector carried by the center feed line and located adjacent to an antenna element having a greatest selected length of the plurality of antenna elements,
wherein the two or more antenna elements having the protrusion enables the antenna to operate at a frequency range while reducing an area of the antenna.

33. The antenna of claim 32, wherein the antenna is one of: a log periodic antenna, a dipole antenna, a monopole antenna, or a yagi-uda antenna.

34. The antenna of claim 32, wherein the plurality of antenna elements extends orthogonally from the center feed line.

35. The antenna of claim 32, wherein the protrusion has a stepped width with an approximately 90-degree step to form an L-shaped antenna element.

36. The antenna of claim 32, wherein the antenna is configured to be communicatively coupled to a signal booster.

37. The antenna of claim 32, wherein the protrusion is configured to provide additional current paths in each of the two or more antenna elements having the protrusion, wherein the additional current paths operate to increase a defined operating frequency of the two or more antenna elements.
